(19) United States
(12) Patent Application Publication
(10) Pub. No.: US 2003/0234299 A1
(43) Pub. Date: Dec. 25, 2003

(54) Cartridge type coater

(76) Inventors: Toshio Hosoda, Shizuoka (JP); Shinji Tani, Aichi (JP); Yoichi Hanai, Aichi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/399,786

(22) PCT Filed: Jul. 29, 2002
(86) PCT No.: PCT/JP02/07677

(30) Foreign Application Priority Data
Aug. 9, 2001 (JP) 2001-242924

(51) Int. Cl. B05B 9/03

(52) U.S. Cl. 239/302

(57) ABSTRACT

Provided between a housing (2) and a paint cartridge (20) is a magnetic holding mechanism (32) composed of a permanent magnet (33) provided on a bottom surface (4A) of a cartridge mount portion (4) and a magnetic member (34) provided on a front surface (21A) of a container (21) of the paint cartridge (20). As the container (21) is fitted on the cartridge mount portion (4), the paint cartridge (20) can be fixedly and securely held on the housing (2) by magnetic attraction between the permanent magnet (33) and the magnetic member (34). Accordingly, even if a trouble occurs to one of components which are operatively connected with the cartridge type coating machine (1), the paint cartridge (20) can be securely retained on the housing (2) by the magnetic holding mechanism (32).

### TECHNICAL FIELD

This invention relates to a cartridge type coating machine, employing a plural number of paint cartridges of different colors which are adapted to be interchangeably and replaceably set in position on the machine to permit color changes during a coating operation.

### BACKGROUND ART

Generally, various types of coating machines have been and are resorted to for coating work pieces such as vehicle bodies or the like, including rotary atomizing head type coating machines, hydraulic atomization type coating machines and pneumatic atomization type coating machines. In this connection, there are strong demands for a coating machine which can reduce the amounts of paint and solvent to be discarded or consumed at the time of changing the paint color and which can cope with a large number of paint colors.

As a coating machine which can reduce the amounts of discarding paint and solvent consumption and which can cope with a large number of colors, there have been known cartridge type coating machines (e.g., as disclosed in Japanese Patent Laid-Open No. H11-262699 and Japanese Patent Laid-Open No. H8-229446). In the case of this cartridge type coating machine, arrangements are made to replaceably mount paint cartridges, which are filled with different colors, on a housing of the coating machine.

Further, in the case of the conventional cartridge type coating machine mentioned above, the machine includes a housing which is provided with a sprayer mount portion and a cartridge mount portion in its front and rear end portions, respectively, a rotary atomizing head type or hydraulic atomization type sprayer unit which is mounted on the sprayer mount portion of the housing to spray supplied paint toward a work piece, and paint cartridges which are filled with different paint colors and adapted to be replaceably mounted on the cartridge mount portion of the housing.

The paint cartridges are each constituted largely by a cylindrical container which is closed at the opposite ends and internally filled with paint, and a feed tube which is extended out axially from the container to spurt out paint in the cartridge container therethrough. Further, the cartridge mount portion of the housing is formed in the shape of a bottomed cavity which is open on the rear side. A paint cartridge is set on the cartridge mount portion by fitting engagement therewith of the cartridge container.

As a paint cartridge is set on the cartridge mount portion on the housing, a vacuum space is defined in the cartridge mount portion by an O-ring which is provided around the outer periphery of the cartridge container and brought into sliding contact with inner peripheral surfaces of the cartridge mount portion. Air in the vacuum space is sucked out through a suction passage to hold the paint cartridge fixedly on the cartridge mount portion by suction grip.

With a cartridge type coating machine which is arranged in the manner as described above, paint cartridges of different colors are selectively mounted on the cartridge mount portion during a coating operation. The paint in the cartridge container is spurted out toward the sprayer unit through the feed tube and then sprayed toward a work piece by the sprayer unit.

The paint cartridge on the coating machine is simply replaced by a cartridge of a next color at the time of changing the paint color, that is to say, the paint color can be changed without entailing wasteful paint discarding or solvent consumption.

Further, in the case of the above-described conventional cartridge type coating machine, as mentioned above, an O-ring which is provided around the outer periphery of the cartridge container is brought into sliding contact with inner peripheral surfaces of the cartridge mount portion to define a vacuum space therebetween. The paint cartridge is fixed on the cartridge mount portion by suction force which is produced by sucking air out of the vacuum space. However, since the 0ring which is attached to the paint cartridge is simply held in sliding contact with the inner periphery of the cartridge mount portion, it is difficult to seal up the vacuum space completely by the O-ring. Therefore, it is inevitable that atmospheric air incessantly creeps into the vacuum space. This means that, in order to maintain the suction grip on the paint cartridge, a vacuum generator has to be constantly kept in operation to suck out air continuously from the vacuum space.

In case the vacuuming operation is stopped due to a damage or a trouble occurring to the vacuum generator or to suction air piping or hose, it becomes difficult to maintain the vacuum space under negative pressure, and the paint cartridge is likely to fall off the housing to compel stoppage of the coating line which would result in a detrimental drop of productivity.

Further, in the course of a coating operation, there may arise a need for stopping the coating line (or for putting the coating line at rest) for some reasons. On such an occasion, however, irrespective of the stoppage of the coating line, it is necessary to keep the vacuum generator in operation as long as the paint cartridge is mounted on the housing of the coating machine. This naturally invites increases in running cost.

Furthermore, as the container of a paint cartridge is mounted on or dismantled from the cartridge mount portion of the housing, the O-ring is brought into frictional contact with inner peripheral surfaces of the cartridge mount portion. Therefore, the O-ring which is repeatedly twisted by frictional contact is susceptible to damages and generally requires replacements at a higher frequency.

Besides, when the paint cartridge is mounted on or dismantled from the housing of the coating machine, the O-ring is twisted as mentioned above and as a result deformed and the container of the paint cartridge is deviated from the center axis of the cartridge mount portion. Thereby, the fore end of the feed tube which is extended forward from the container is also deviated from the center axis of the coating machine. As a consequence, part of paint which is supplied to the sprayer unit through the feed tube tend to overflow to the outside to lower the operational reliability of the coating machine.

### DISCLOSURE OF THE INVENTION

In view of the above-mentioned problems with the prior art, it is an object of the present invention to provide a cartridge type coating machine which can hold a paint cartridge in a cartridge mount portion fixedly in a secure state without applying an external force, for example, without applying a suction force by the use of a vacuum generator or the like, permitting to improve productivity and reliability of the machine while cutting its running cost.

In accordance with the present invention, there is provided a cartridge type coating machine, which includes a housing with a sprayer unit mount portion and a cartridge mount portion respectively on front and rear sides thereof, a sprayer unit mounted on the sprayer unit mount portion of the housing to spray supplied paint toward a work piece, and a paint cartridge adapted to be replaceably set in the cartridge mount portion of the housing and filled with paint for supply to the sprayer unit.

In order to achieve the above-stated objective, the cartridge type coating machine according to the present invention is characterized by the provision of a magnetic holding mechanism provided between the cartridge mount portion of the housing and the paint cartridge to releasably and fixedly hold the paint cartridge in the cartridge mount portion of the housing by magnetic force.

With the arrangements just described, as a paint cartridge is mounted on the cartridge mount portion of the housing, it can be securely fixed to the cartridge mount portion by magnetic force of a permanent magnet or electromagnet without applying an external force, for example, by the use of a vacuum generator or the like.

In a preferred form of the present invention, the magnetic holding mechanism is constituted by permanent magnets attached to one of the cartridge mount portion of the housing and the paint cartridge and magnetic members attached to the other one of the cartridge mount portion and the paint cartridge.

With the arrangements just described, as a paint cartridge is mounted on the cartridge mount portion of the housing, the magnetic member which is attached to the paint cartridge, for example, is attracted to the permanent magnet on the side of the cartridge mount portion and as a result the paint cartridge is securely and fixedly held in the latter by the magnetic holding mechanism.

According to the present invention, preferably, the magnetic holding mechanism is constituted by a first permanent magnet attached to one of the cartridge mount portion of the housing and the paint cartridge, and a second permanent magnet attached to the other one of the cartridge mount portion and the paint cartridge in such a way as to confront the first permanent magnet through opposite magnetic poles.

With the arrangements just described, as a paint cartridge is mounted on the cartridge mount portion of the housing, the second permanent magnet which is attached on the paint cartridge, for example, is attracted to the first permanent magnet which is attached on the side of the cartridge mount portion, and as a result the paint cartridge is securely and fixedly held in the latter by the magnetic holding mechanism.

According to a further preferred form of the present invention, the magnetic holding mechanism is constituted by a first magnet group consisting of a plural number of permanent magnets and attached to one of the cartridge mount portion of the housing and the paint cartridge, the permanent magnets of the first magnet group being arranged in a row and alternately reversed in magnetic pole position, and a second magnet group consisting of a plural number of permanent magnets and attached to the other one of the cartridge mount portion of the housing and the paint cartridge, the permanent magnets of the second magnet group being arranged into a row in confronting relation with the first magnet group and reversed in magnetic pole position relative to said first magnet group.

With the arrangements just described, as a paint cartridge is mounted on the cartridge mount portion of the housing, the first and second magnet groups are attracted toward each other, and as a result the paint cartridge is securely fixed in the cartridge mount portion. Further, when the first and second magnet groups come closer to each other, homopolar repulsions and heteropolar attractions take place between permanent magnets of the first and second magnet groups. Therefore, at the time of mounting the paint cartridge on the housing, positional deviations between the cartridge mount portion and the paint cartridge, if any, can be corrected by the repulsive and attracting actions of the permanent magnets.

According to the present invention, preferably an ejection air supply passage is provided in the housing for supplying ejection air between the cartridge mount portion and the paint cartridge at the time of dismantling the latter from the cartridge mount portion of the housing.

With the arrangements just described, at the time of dismantling the paint cartridge from the cartridge mount portion of the housing, ejection air is supplied to a space between the cartridge mount portion and the paint cartridge through the ejection air supply passage. Whereupon, the paint cartridge is pushed outward by ejection air and can be easily dismantled or removed from the cartridge mount portion of the housing against the magnetic force of the magnetic holding mechanism.

According to a further preferred form of the present invention, the cartridge mount portion of the housing is formed in the shape of a bottomed cylindrical cavity, and the paint cartridge is provided with a cylindrical container filled with paint and a feed tube extended axially forward from a front end of the container, and the coating machine further comprises a seal member provided either on a bottom surface of the cartridge mount portion or on a front surface of the container, the seal member being brought into abutting engagement with either the front surface of the paint cartridge or the bottom surface of the cartridge mount portion to form an ejection air space therebetween when the paint cartridge is set in the cartridge mount portion of the housing.

With the arrangements just described, as soon as a paint cartridge is set on the cartridge mount portion of the housing, an ejection air space is formed and defined between the cartridge mount portion and the paint cartridge by the seal member. Therefore, upon supplying air to the ejection air space, the air pressure can be efficiently acted on the container of the paint cartridge, permitting to dismantle the paint cartridge extremely in a facilitated manner. Besides, the seal member is simply abutted against a bottom surface of the cartridge mount portion or a front surface of the cartridge container, so that there is little possibility of the seal member being subjected to twisted deformation or sliding abrasion at the time of loading or unloading a paint cartridge to or from the coating machine.

Further, according to the present invention, preferably a projection and a recess of complementary shapes are provided on confronting surfaces of the above-mentioned permanent magnet and the opposing magnetic member for fitting engagement with each other. Similarly, according to the present invention, a projection and a recess of complementary shapes are preferably provided on confronting surfaces of the above-mentioned first and second permanent magnets for fitting engagement with each other.

With the arrangements just described, as opposing permanent magnets or a permanent magnet and an opposing magnetic member are attracted toward each other, the projection and recess on their confronting surfaces are brought into fitting engagement with each other, contributing to locate the paint cartridge into a predetermined position within the cartridge mount portion of the housing.

According to a further preferred form of the present invention, the magnetic holding mechanism is constituted by an electromagnet provided on one of the cartridge mount portion of the housing and the paint cartridge, and a magnetic member provided on the other one of the cartridge mount portion and the paint cartridge.

With the arrangements, at the time of mounting a paint cartridge on the cartridge mount portion of the housing, power is supplied to energize the electromagnet which is provided, for example, on the side of the cartridge mount portion. Upon energizing the electromagnet, the magnetic member on the side of the paint cartridge is attracted by the electromagnet, and as a result the paint cartridge is securely fixed in the cartridge mount portion of the machine housing.

### BRIEF DESCRIPTION OF THE DRAWINGS

In the accompanying drawings:

FIG. 1 is a vertical sectional view of a cartridge type coating machine according to a first embodiment of the present invention, showing together a paint cartridge which is loaded on the coating machine;

FIG. 2 is a vertical sectional view on an enlarged scale of the paint cartridge which is loaded in a cartridge mount portion within a housing shown in FIG. 1;

FIG. 3 is a right-hand side view of the cartridge mount portion of the housing, showing the bottom side of the cartridge mount portion as taken in the direction of arrows III-III of FIG. 2, with the paint cartridge removed for the convenience of illustration;

FIG. 4 is a vertical sectional view of one paint cartridge unit;

FIG. 5 is a left-hand side view of the paint cartridge as taken in the direction of arrows V-V of FIG. 2 to show the front side of the cartridge;

FIG. 6 is an enlarged perspective view of a permanent magnet and a magnetic member shown in FIG. 2;

FIG. 7 is a right-hand side view similar to FIG. 3, showing the bottom side of a cartridge mount portion of a housing according to a second embodiment of the invention together with first magnet groups;

FIG. 8 is a left-hand side view similar to FIG. 5, showing the front side of a paint cartridge according to the second embodiment together with second magnet groups;

FIG. 9 is a vertical sectional view similar to FIG. 2, showing on an enlarged scale a cartridge mount portion of a housing according to a third embodiment of the present invention together with a paint cartridge;

FIG. 10 is a vertical sectional view similar to FIG. 2, showing on an enlarged scale a cartridge mount portion of a housing according to a fourth embodiment of the invention together with a paint cartridge;

FIG. 11 is a schematic perspective view on an enlarged scale of a permanent magnet and a magnetic member shown in FIG. 10;

FIG. 12 is a vertical sectional view similar to FIG. 2, showing on an enlarged scale a cartridge mount portion of a housing according to a fifth embodiment of the present invention together with a paint cartridge;

FIG. 13 is a schematic perspective view on an enlarged scale of a permanent magnet and a magnetic member in a first modification according to the present invention; and

FIG. 14 is a schematic perspective view on an enlarged scale of a permanent magnet and a magnetic member in a second modification according to the present invention.

### BEST MODE FOR CARRYING OUT THE INVENTION

Hereafter, the cartridge type coating machine according to the present invention is described more particularly with reference to the accompanying drawings, by way of its preferred embodiments which are each in the form of a rotary atomizing head type coating machine.

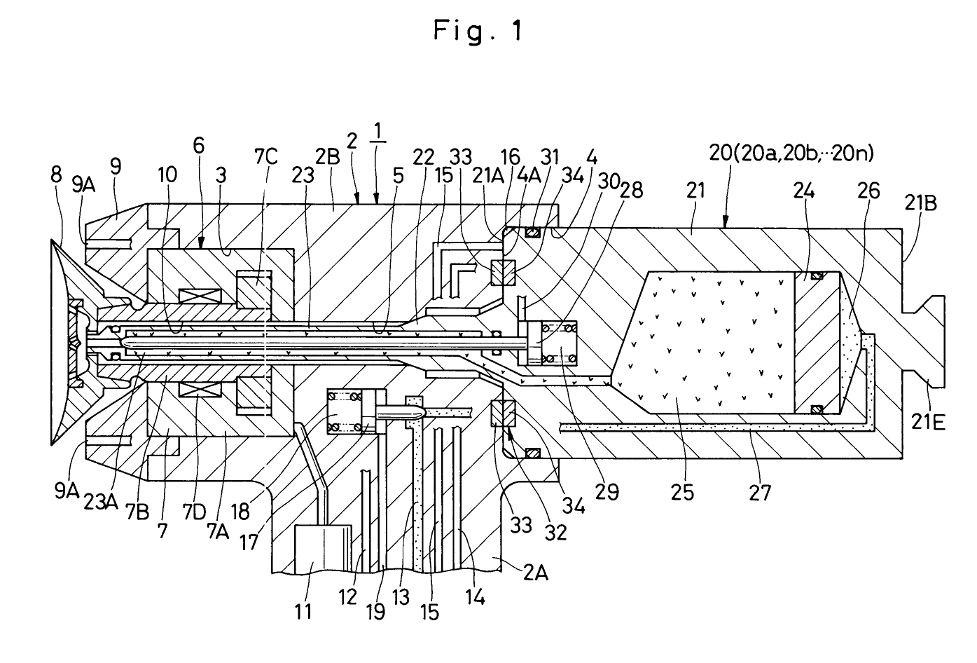

Referring first to FIGS. 1 through 6, there is shown a first embodiment of the present invention. In these figures, indicated at 1 is a cartridge type coating machine (hereinafter simply referred to as “coating machine 1” for brevity) which is provided on a coating robot or a reciprocator (not shown), for example. The coating machine 1 is largely constituted by a housing 2, feed tube passage holes 5 and 10, sprayer unit 6, and paint cartridges 20.

The housing 2 of the coating machine 1 is formed of an engineering plastics material, for example, such as PTFE, PEEK, PEI, POM, PI, PET and so forth. The housing 2 is constituted by a neck portion 2A to be detachably attached, for example, on a wrist portion (not shown) of a coating robot, and a head portion 2B which is formed integrally at the fore end of the neck portion 2A.

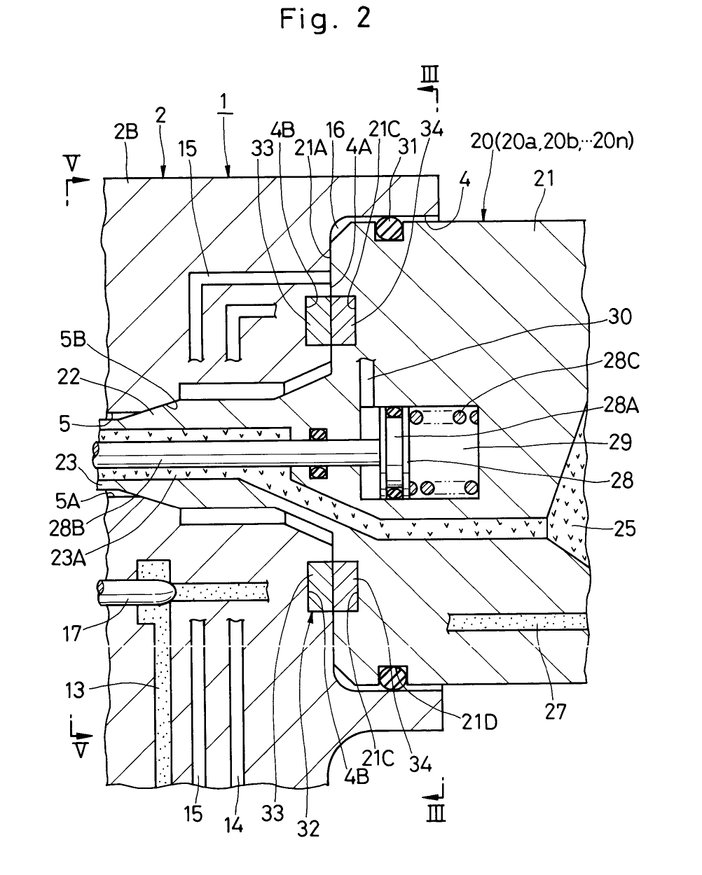

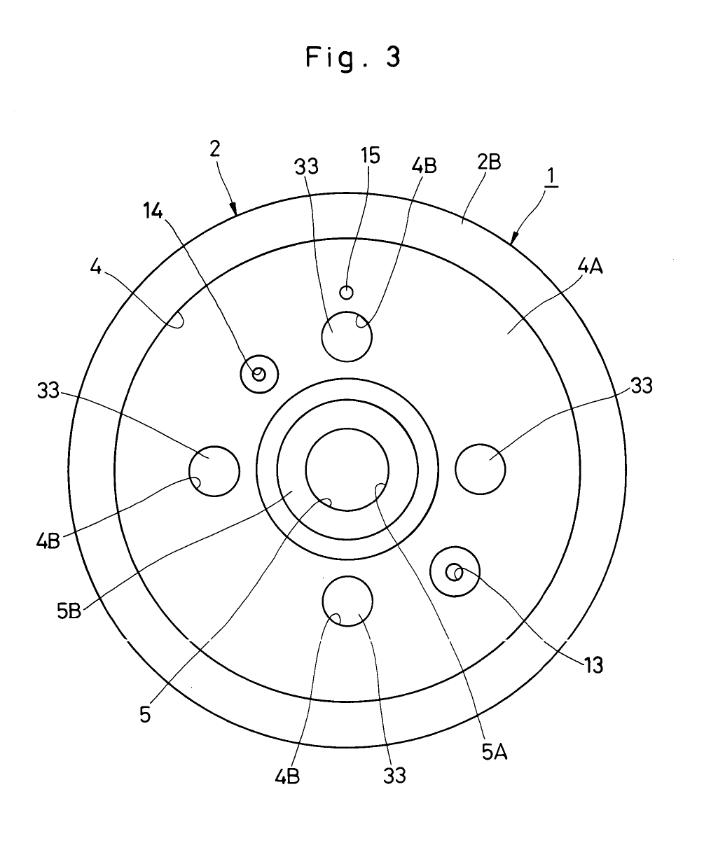

In this instance, a sprayer unit mount portion 3 in the form of a cylindrical cavity is provided on the front side of the head portion 2B of the housing 2, and a cartridge mount portion 4 similarly in the form of a cylindrical cavity is provided on the rear side of the head portion 2B. Further, the cartridge mount portion 4 is in the form of a bottomed blind hole which is open only on the rear side, and, as shown particularly in FIGS. 2 and 3, provided with a plural number of magnet fitting grooves 4B, for example, four magnet fitting grooves 4B on its bottom surface 4A at angularly spaced positions in the circumferential direction for mounting permanent magnets 33, which will be described hereinafter.

Indicated at 5 is a feed tube passage hole which is provided on the side of the housing 2 to extend between and in communication with the sprayer unit mount portion 3 and the cartridge mount portion 4. This feed tube passage hole 5 on the side of the housing is composed of a front feed tube passage portion 5A of a small diameter, and a rear conically converging portion 5B which diameter is gradually reduced in a conical shape toward the front feed tube passage portion 5A. In this instance, the feed tube passage portion 5A is formed in coaxial relation with a feed tube passage hole 10 on the side of the sprayer unit, which will be described hereinafter. Further, the conically converging portion 5B is held in abutting engagement with a conical projection 22 of the paint cartridge 20, which will be described hereinafter, to hold the latter in position in radial and axial directions.

Denoted at 6 is a sprayer unit for spraying paint toward a work piece. The sprayer unit 6 is mounted in the sprayer unit mount portion 3 on the head portion 2B of the housing. In this instance, as shown in FIG. 1, the sprayer unit 6 is largely constituted by an air motor 7 with a motor case 7A, rotational shaft 7B, air turbine 7C and air bearing 7D, a rotary atomizing head 8 which is put in rotation by the air motor 7 for atomizing paint into finely divided particles by centrifugal atomization and spraying same toward a work piece, and a shaping air ring 9 which is located at the front end of the air motor 7 and provided with a multitude of shaping air outlet holes 9A (only two of which are shown in the drawings).

Indicated at 10 is a feed tube passage hole which is provided on the side of the sprayer unit 6. This feed tube passage hole 10 is extended axially through the rotational shaft 7B of the air motor 7. In this instance, the base end of the feed tube passage hole 10 on the side of the sprayer unit is opened into the feed tube passage portion 5A of the feed tube passage hole 5 on the side of the housing, while its fore end is opened into the rotary atomizing head 8. Further, the feed tube passage hole 10 on the side of the sprayer unit is formed in coaxial relation with the afore-mentioned feed tube passage portion 5A. The feed tube 23 of the paint cartridge 20 is extractably fitted into these feed tube passage holes 5 and 10.

Designated at 11 is a high voltage generator which is provided in the neck portion 2A of the housing 2. The high voltage generator 11 is constituted, for example, by a Cockcroft circuit which is adapted to elevate a source voltage from a power supply (not shown) to a high voltage, for example, to a level between −60 kv and −120 kv. The output side of the high voltage generator 11 is electrically connected, for example, to the air motor 7. A high voltage is therefore applied to the rotary atomizing head 8 from the high voltage generator 11 through the rotational shaft 7B of the air motor 7 to charge the paint directly.

Indicated at 12 are a plural number of air passages which are provided in the neck portion 2A of the housing 2 and connected to a control air source (not shown). The air passages 12 includes a turbine air passage which supplies turbine air for controlling the air motor 7, a bearing air passage, a brake air passage and a shaping air passage which supplies shaping air for shaping the paint spray pattern. In the case of the particular embodiment shown, only one air passage is shown to represent the various air passages as mentioned above.

Indicated at 13 is an extruding thinner passage which is provided on the side of the housing 2. One end of this extruding thinner passage 13 is connected to an extruding thinner supply unit (not shown) which supplies extruding thinner toward the paint cartridge 20. The other end of the extruding thinner passage 13 is opened into a female coupling portion (not shown) which is provided on the bottom surface 4A of the cartridge mount portion 4, for communication with an extruding thinner passage 27 on the side of the paint cartridge, which will be described hereinafter.

Indicated at 14 is a pilot air passage which is provided on the side of the housing 2. One end of this pilot air passage 14 is connected to a paint valve pilot air source (not shown) through pilot air piping. The other end of the pilot air passage 14 is opened into a male coupling portion (not shown) which is provided on the bottom surface 4A of the cartridge mount portion 4, for communication with a pilot air passage 30 on the side of the paint cartridge, which will be described hereinafter.

Denoted at 15 is an ejection air supply passage which is provided in the housing 2 and opened in the bottom surface 4A of the cartridge mount portion 4. This ejection air supply passage 15 is connected to an ejection air source through air piping (both of which are not shown in the drawings). Through the ejection air supply passage 15, ejection air is supplied to an ejection air space 16 (shown in FIG. 2) which is defined between the cartridge mount portion 4 and the container 21 of the paint cartridge 20, permitting to dismantle the latter from the cartridge mount portion 4.

Indicated at 17 is a thinner valve which is provided in the head portion 2B of the housing 2. The thinner valve 17 is accommodated in a thinner valve receptacle cavity 18. Normally, the extruding thinner passage 13 on the side of the housing is blocked by the thinner valve 17 to stop thinner supply to the extruding thinner chamber 26 of the paint cartridge 20. On the other hand, when pilot air is supplied to the thinner valve 17 from the thinner valve pilot air source (not shown) through the pilot air passage 19, the thinner valve puts the extruding thinner passage 13 into communication to permit thinner supply to the extruding thinner chamber 26.

Indicated at 20a, 20b . . . 20n are paint cartridges which are filled with different colors, color a, color b, . . . color n, (hereinafter generally referred to as “paint cartridges 20”) for supply to the rotary atomizing head 8.

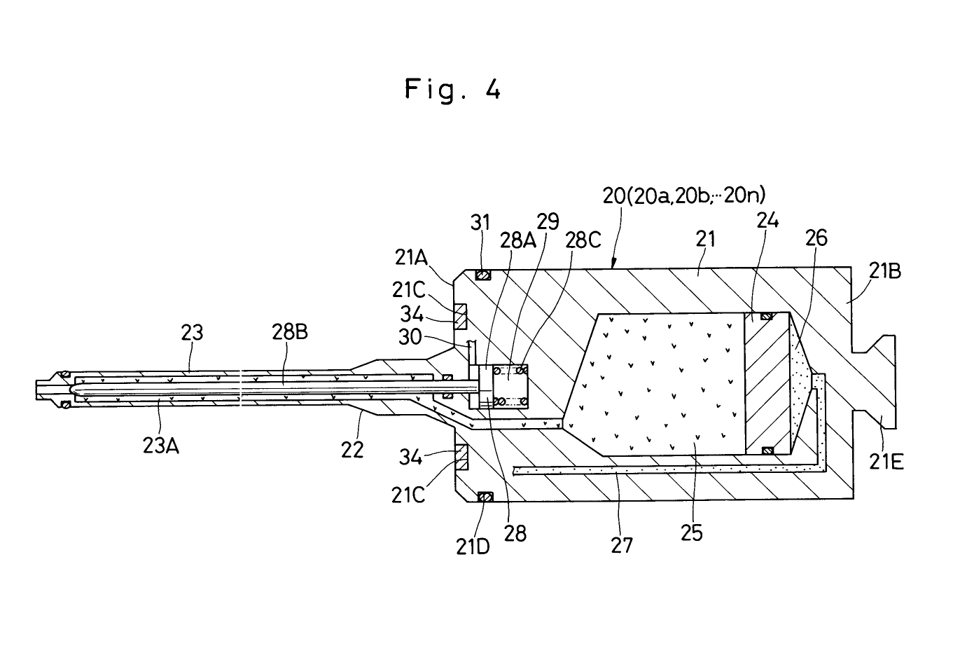

Further, as shown in FIG. 4, the paint cartridges 20 are each largely constituted by a container 21 and a feed tube 23.

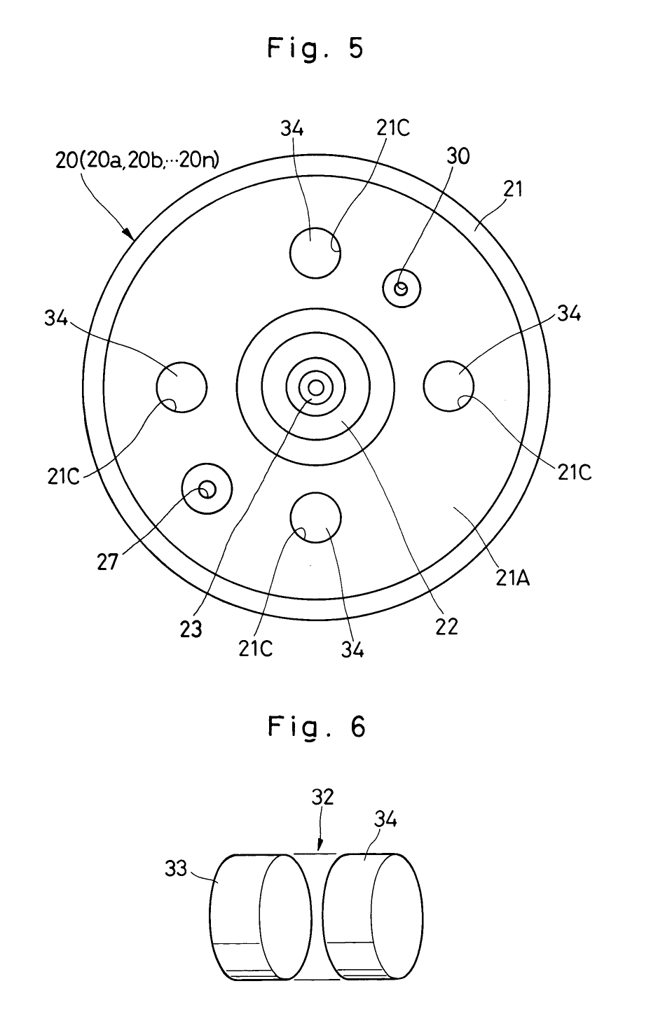

Denoted at 21 is a container which constitutes a main 10 body of the paint cartridge 20. The container 21 is formed in the shape of a cylindrical shell (cylinder) of a diameter slightly smaller than the inside diameter of the cartridge mount portion 4 of the housing. Front and rear ends of the container 21 are closed with front and rear surfaces 21A and 21B, respectively. As shown in FIG. 5, a plural number of magnetic member fitting grooves 21C are formed in the front surface 21A of the container 21, for example, at four angularly spaced positions in the circumferential direction, to attach thereto magnetic members 34, which will be described 20 hereinafter. Further, at a position close to the front end, an annular groove 21D is formed around the outer periphery of the container 21 to receive therein an O-ring 31, which will be described hereinafter. On the other hand, formed on the rear surface 21B is a knob portion 21E to be gripped by a gripper at the time of replacement of the paint cartridge 20.

Designated at 22 is a conical projection which is projected axially forward from and at a center position of the front surface 21A. The conical projection 22 which forms part of the container 21 is gradually reduced in diameter in the forward direction. As the cartridge container 21 is fitted into the cartridge mount portion 4 of the housing 2, the conical projection 22 is brought into fitting engagement with the conically converging portion 5B of the feed tube passage hole 5 thereby to set the container 21 in position in the axial and radial directions.

Further, indicated at 23 is a feed tube which is extended axially forward from a distal end of the conical projection 22 of the cartridge container 21. A paint passage 23A is formed coaxially through the feed tube 23. The base end of the paint passage 23A is connected to a paint chamber 25, which will be described hereinafter, while its fore end is opened toward the rotary atomizing head 8. On the other hand, when the paint cartridge 20 is set in the cartridge mount portion 4, the feed tube 23 is passed into the feed tube passage holes 5 and 10 and its fore end is placed within the rotary atomizing head 8.

In this instance, the feed tube 23 serves to receive a supply of paint from the paint chamber 25, which will be described hereinafter, and convey same through the paint passage 23A, letting the paints spurt from the fore end of the paint passage 23A toward the rotary atomizing head 8. Besides, at the time of replenishing paint into the paint chamber 25, the feed tube 23 is utilized as a paint replenishing port.

Indicated at 24 is a piston which is axially slidably fitted in the cartridge container 21. By the piston 24, the internal space of the cartridge container 21 is divided into a paint chamber 25 which is in communication with the paint passage 23A of the feed tube 23, and an extruding thinner chamber 26 which accommodates thinner as an extruding liquid.

Denoted at 27 is an extruding thinner passage on the side of the paint cartridge. This extruding thinner passage 27 is extended axially through the casing of the cartridge container 21 along the outer peripheral side of the latter. In this instance, one end of the extruding thinner passage 27 on the side of the paint cartridge is opened into a male coupling portion (not shown) which is provided on the front surface 21A of the cartridge container 21, while the other end is communicated with the extruding thinner chamber 26. As soon as the paint cartridge 20 is set in the housing 2, with the extruding thinner passage 27 on the side of the cartridge connected with the extruding thinner passage 13 on the side of the housing, thinner can be supplied to the extruding thinner chamber 26. As a result, the piston 24 in the cartridge container 21 is pushed toward the feed tube 23 to extrude the paint in the paint chamber 25 toward the rotary atomizing head 8.

The thinner which is employed as an extruding liquid should be of an electrically insulating type or of a high electric resistance type in order to prevent leaks of the high voltage of the high voltage generator 11 through the thinner.

Indicated at 28 is a paint valve which is provided in the casing of the cartridge container 21. The paint valve 28 is accommodated in a paint valve receptacle cavity 29, and largely constituted by a piston 28A which is slidably fitted in the paint valve receptacle cavity 29, a valve member 28B for opening and closing the paint passage 23A of the feed tube 23, and a valve spring 28C for biasing the valve member 28B in a closing direction through the piston 28A. Consequently, the valve member 28B is arranged to normally close the paint passage 23A under the influence of the biasing force of the valve spring 28C to suspend paint supply to the rotary atomizing head 8. On the other hand, as soon as pilot air is supplied from a paint valve pilot air source (not shown) through the pilot air passage 14 on the side of the housing and a pilot air passage 30 on the side of the paint cartridge, the piston 28A is displaced in an opening position against the action of the valve spring 28C, bringing the paint passage 23A into communication to permit paint supply to the rotary atomizing head 8.

Indicated at 31 is an O-ring which is fitted in the annular groove 21D of the cartridge container 21 as a seal member. When the cartridge container 21 is set in the cartridge mount portion 4 of the housing 2, the O-ring 31 is brought into sliding contact with the inner peripheral surfaces of the cartridge mount portion 4. As a consequence, the O-ring 31 contributes to enhance the air-tightness of the ejection air space 16 which is defined between the cartridge mount portion 4 and the cartridge container 21.

Denoted at 32 is a magnetic holding mechanism which is provided between the cartridge mount portion 4 and the paint cartridge 20. This magnetic holding mechanism 32 serves to detachably fasten the paint cartridge 20 to the cartridge mount portion 4 by magnetic attraction. As shown in FIG. 6, the magnetic holding mechanism 32 is constituted by permanent magnets 33 and magnetic members 34.

Indicated at 33 are a plural number of permanent magnets, for example, four permanent magnets which are attached on the bottom surface 4A of the cartridge mount portion 4 of the housing 2. In this instance, the permanent magnets 33 are each formed in a short cylindrical shape by the use of a magnetic material with a large magnetic coersive force, for example, by the use of metal magnet, ferrite magnet or the like. The permanent magnets 33 are fixedly set in the magnet fitting grooves 4B on the bottom surface 4A of the cartridge mount portion, and have the respective outer surfaces located substantially flush with the bottom surface 4A.

Indicated at 34 are a plural number of magnetic members, for example, four magnetic members which are provided on the side of the container 21 of the paint cartridge 20. In this instance, the magnetic members 34 are each formed in a short cylindrical shape by the use of a magnetic material which is small in coercive force and large in relative permeability, for example, by the use of a magnetic material such as silicon steel, permalloy or the like. Each one of the magnetic members 34 are fixedly set in the magnetic member fitting grooves 21C in the front surface 21A of the cartridge container 21 in such a way as to confront face to face with the permanent magnets 33. The outer surfaces of the magnetic members 34 are located substantially flush with the front surface 21A of the cartridge container 21.

As the container 21 of the paint cartridge 20 is set in the cartridge mount portion 4 of the housing 2, the magnetic members 34 on the side of the paint cartridge 20 are magnetically attracted to the permanent magnets 33 on the side of the housing 2. Therefore, the paint cartridge 20 is fixedly gripped in the cartridge mount portion 4 by the magnetic holding mechanism 32.

In order to dismantle the paint cartridge 20 which is fixedly held in the cartridge mount portion 4 of the housing 2 by the magnetic force of the magnetic holding mechanism 32, ejection air is supplied to the ejection air space 16 through the ejection air supply passage 15. Whereupon, the paint cartridge 20 is pushed out by the air pressure in the ejection air space 16, permitting to dismantle the cartridge 20 against the magnetic force of the magnetic holding mechanism 32.

In the case of the present embodiment, the magnetic holding mechanism 32 has the permanent magnets 33 on the side of the housing 2 and the magnetic members 34 on the side of the paint cartridge 20. Of course, instead of this combination, there may be employed an arrangement in which the magnetic members 34 are located on the side of the housing 2 and the permanent magnets 33 are located on the side of the paint cartridge 20. Alternatively, in addition to the permanent magnets 33 which are provided on the side of the housing 2, other permanent magnets may be provided also on the side of the paint cartridge 20 with a different magnetic pole arrangement relative to the permanent magnets 33 on the side of the housing 2. In any case, the paint cartridge 20 can be fixedly held in the housing 2 by magnetic attraction.

Having the arrangements as described above, the cartridge type coating machine 1 according to the present embodiment is used in the following manner, for example, in coating color a.

In the first place, a paint cartridge 20a which is filled with the color a is set in the cartridge mount portion 4 of the housing 2. Then, the rotary atomizing head 8 is put in high speed rotation by the air motor 7, while shaping air is spurted out from the shaping air ring 9. In this state, the thinner valve 17 and paint valve 28 are opened, whereupon extruding thinner is supplied to the extruding thinner chamber 26 of the paint cartridge 20a through the extruding thinner passages 13 and 27. As a result, the color a paint in the paint chamber 25 is pushed out by the piston 24 under the pressure of the extruding thinner, and spurted out toward the rotary atomizing head 8 through the paint passage 23A of the feed tube 23. The paint of color a which has been spurted into the rotary atomizing head 8 is atomized into finely divided paint particles by the latter, and sprayed toward a work piece in a spray pattern which is controlled by shaping air.

The paint cartridge 20 is loaded on and unloaded from the cartridge mount portion 4 of the housing 2 in the manner as described below.

Firstly, for loading the paint cartridge 20 on the cartridge mount portion 4, the knob portion 21E on the container 21 of the paint cartridge 20 is gripped by an arm (not shown) of a cartridge changer, and the paint cartridge 20 is put into the cartridge mount portion 4 from its front end with the feed tube 23. As a consequence, the feed tube 23 is inserted into the feed tube passage holes 5 and 10, and a front portion of the cartridge container 21 is fitted into the cartridge mount portion 4. As the cartridge container 21 is pushed deeper into the cartridge mount portion 4, it is fixed to the latter by magnetic force of the magnetic holding mechanism 32, that is, by magnetic attraction of the magnetic members 34 on the front surface 21A of cartridge container 21 toward the permanent magnets 33 which are provided on the bottom surface 4A of the cartridge mount portion 4.

Further, at the time when the paint cartridge 20 is set on the housing 2 by the magnetic holding mechanism 32, the conical projection 22 is brought into abutting engagement with the conically converging portion 5B of the feed tube passage hole 5 on the side of the housing to locate the feed tube 23 at the center of the rotary atomizing head 8.

On the other hand, at the time of dismantling the paint cartridge 20 from the cartridge mount portion 4, ejection air is supplied to the ejection air space 16 through the ejection air supply passage 15. Whereupon, the air pressure in the ejection air space 16, which is hermetically sealed by the O-ring 31, is increased to push the paint cartridge 20 away from the bottom surface 4A of the cartridge mount portion 4 against the force of magnetic attraction between the magnetic member 34 and the permanent magnet 33 of the magnetic holding mechanism 32. In this state, the paint cartridge 20 can be easily dismantled from the cartridge mount portion 4 by gripping and extracting the knob portion 21E of the container 21 with an arm of cartridge changer (not shown).

Thus, according to the first embodiment, the magnetic holding mechanism 32 which is provided between the housing 2 and the paint cartridge 20 is constituted by the permanent magnet 33 which is provided on the bottom surface 4A of the cartridge mount portion 4 and the magnetic member 34 which is provided on the front surface 21A of the container 21. Upon fitting the container 21 into the cartridge mount portion 4, the paint cartridge 20 is fixedly retained on the housing 2 by magnetic attraction between the permanent magnet 33 and the magnetic member 34. It follows that even in the event of a trouble to a component which is operatively connected to the cartridge type coating machine 1, the paint cartridge 20 can be fixedly retained on the housing 2 without applying an external force by the use of an external device like a vacuum generator, which has thus far been resorted to on such occasions.

As a consequence, the paint cartridge 20 is prevented from getting loose and falling off the housing 2, precluding the undesirable situations which would require to stop the coating line and thus ensuring high productivity of coating operation. In addition, the use of the magnetic forces of the permanent magnets 33 contributes to lower the running cost and to enhance convenience in handling.

Further, since the ejection air supply passage 15 is opened in the bottom surface 4A of the cartridge mount portion 4 of the housing 2, the paint cartridge 20 can be easily dismantled from the cartridge mount portion 4 as soon as ejection air is supplied to the ejection air space 16 through the ejection air supply passage 15. In other words, the paint cartridge 20 can be dismantled in an efficient manner.

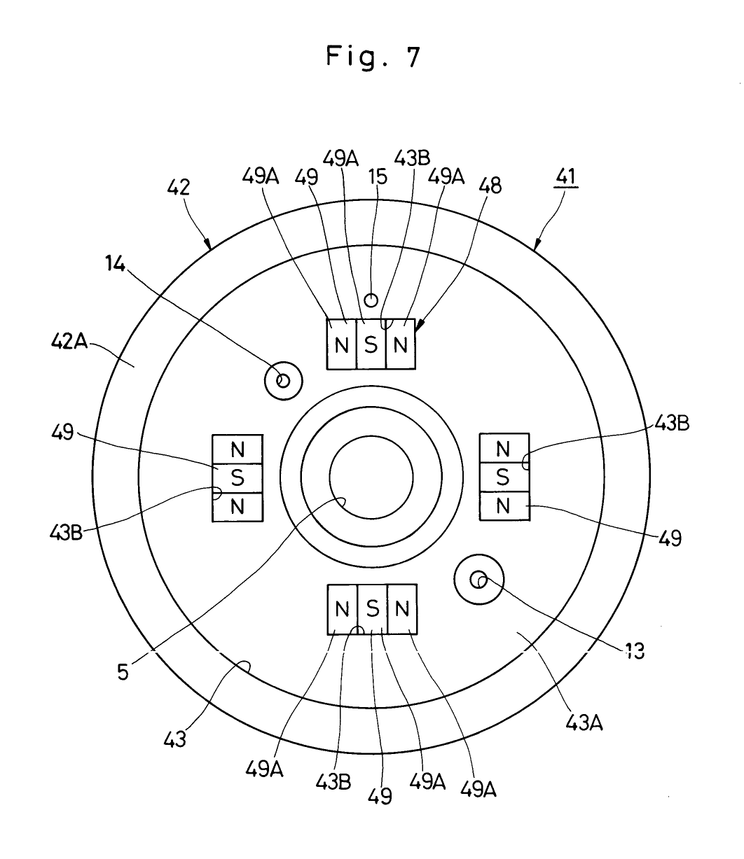

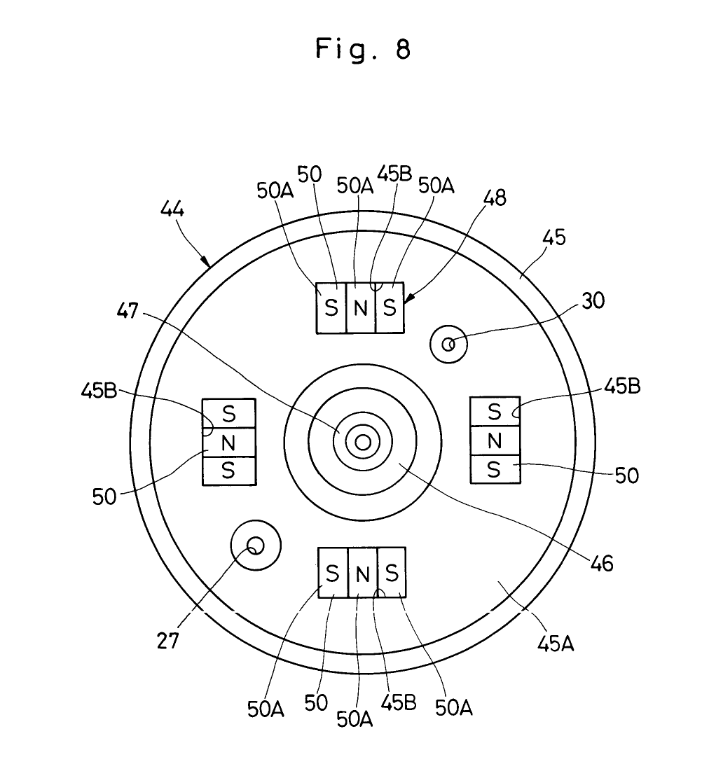

Now, turning to FIGS. 7 and 8, there is shown a second embodiment of the present invention. This embodiment has features in that the magnetic holding mechanism is constituted by a first magnet group consisting of rows of a plural number of permanent magnets which are provided either on the side of the cartridge mount portion of the housing or on the side of the paint cartridge and alternately changed in magnetic pole position, and a second magnet group likewise consisting of rows of a plural number of permanent magnets which are provided on the other one of the cartridge mount portion of the housing and the paint cartridge and alternately changed in magnetic pole position inversely relative to confronting permanent magnets of the first magnet group. In the following description of the second embodiment, those component parts which are identical with the counterparts in the foregoing first embodiment are simply designated by the same or similar reference numerals to avoid repetitions of same explanations.

Indicated at 41 is a cartridge type coating machine according to the present embodiment, and at 42 a housing of the coating machine 41. In this instance, a cartridge mount portion 43 in the form of a cylindrical cavity is formed on the rear side of a head portion 42A of a housing 42. Further, a plural number of magnet fitting grooves 43B, for example, four magnet fitting grooves 43B are provided in a bottom surface 43A of the cartridge mount portion 43 at angularly spaced positions in the circumferential direction for attaching a first magnet group of permanent magnets 49.

Designated at 44 (FIG. 8) is a paint cartridge according to the present embodiment, which is replaceably set in the cartridge mount portion 43 of the housing 42. Similarly to the counterpart in the foregoing first embodiment, the paint cartridge 44 is largely constituted by a container or casing 45, a conical projection 46 and a feed tube 47. Further, the cartridge container 45 is formed in the shape of a hollow cylinder which is closed at the opposite ends, and provided with a plural number of magnet fitting grooves 45B, for example, four magnet fitting grooves at angularly spaced positions on its front surface 45A for attaching a second magnet group of the permanent magnets 50, which will be described hereinafter.

Now, indicated at 48 is a magnetic holding mechanism according to the present embodiment, which is provided between the cartridge mount portion 43 of the housing 42 and the paint cartridge 44. This magnetic holding mechanism 48 is provided also for detachably holding the paint cartridge 44 in the cartridge mount portion 43 of the housing 42 by magnetic attraction, and is largely constituted by first magnet groups 49 and second magnet group 50, as described below.

More specifically, indicated at 49 is the first magnet groups including, for example, four sets of permanent magnets which are fixedly set in the magnet fitting grooves 43B. Each one of the first magnet group 49 is composed of three permanent magnets 49A of rectangular parallelopiped shape which are arranged in a row in the circumferential direction. In this instance, the magnetic poles (S & N) of the permanent magnets 49A are positioned inversely relative to the confronting magnets of the second magnet group 50. Namely, in the case of the particular example shown, the poles of the permanent magnets 49A are arranged in the order of N-S-N.

Indicated at 50 is a second magnet group consisting of rows of a plural number of permanent magnets, for example, four sets of permanent magnets 50A which are fixedly set in magnet fitting grooves 45B on the casing of the container 45 in confronting relation with the first magnet group 49. Similarly to the first magnet group 49, each set of the second magnet group 50 is constituted by three permanent magnets 50A of rectangular parallelopiped shape which are arranged in a row in the circumferential direction. Further, the poles of the permanent magnets 50A are arranged inversely relative to the confronting permanent magnets 49A of the first magnet group 49. Namely, in the case of the particular example shown, the magnetic poles of the permanent magnets 50A are arranged in the order of S-N-S inversely to the order of magnetic poles in the first magnet group 49.

Thus, according to the second embodiment with the above-described arrangements, as soon as the paint cartridge 44 is set on the cartridge mount portion 43 of the housing 42, it can be fixedly held in position within the cartridge mount portion 43 by the magnetic holding mechanism 48, that is, by magnetic attraction between the first magnet group 49 on the side of the housing 42 and the second magnet group 50 on the side of the paint cartridge 44.

Besides, the magnetic poles of the permanent magnets 49A of the first magnet group 49 are arranged in the order of N-S-N, inversely to the opposing permanent magnets 50A of the second magnet group 50 which are arranged in the order of S-N-S. Therefore, as the second magnet groups 50 approaches the first magnet groups 49, homopolar repulsions and heteropolar attractions take place between the permanent magnets 50A on the side of the paint cartridge and the permanent magnets 49A on the side of the housing. It follows that positional deviations between the first magnet group 49 and the second magnet group 50, if any, can be automatically corrected to set and fix the paint cartridge 44 accurately in position relative to the housing 42.

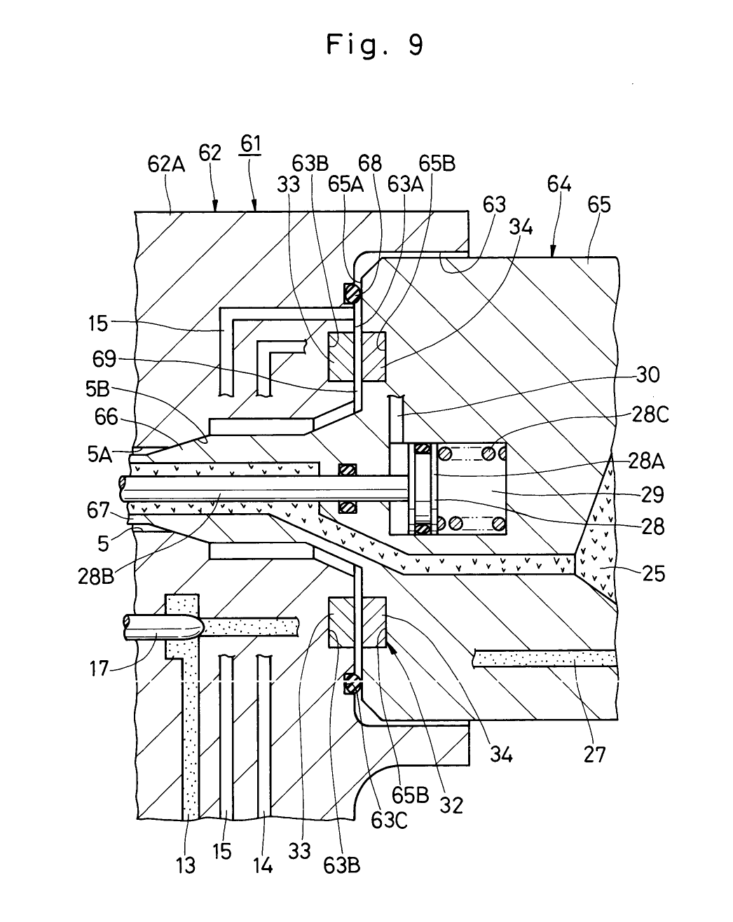

Turning now to FIG. 9, there is shown a third embodiment of the present invention. In the case of this embodiment, the housing of the coating machine is provided with a cartridge mount portion which is also in the shape of a bottomed cylindrical cavity, and each one of paint cartridges is largely constituted by a cylindrical container for a supply of paint and a feed tube which is extended axially forward from the container. However, the present embodiment has features in that a seal member is provided either on a bottom surface of the cartridge mount portion or on an opposing front surface of the container in such a way as to define an ejection air space by abutting engagement with the bottom surface of the cartridge mount portion or the front surface of the container for introduction of ejection air. In the following description of the third embodiment, those component parts which are same as or equivalent with counterparts in the foregoing first embodiment are simply indicated by the same or similar reference numerals to avoid repetitions of same explanations.

Denoted at 61 is a cartridge type coating machine according to the present embodiment, and at 62 is a housing of the coating machine 61. In this instance, the housing 62 is also provided with a cartridge mount portion 63 in the form of a cylindrical cavity on the rear side of its head portion 62A. Further, a plural number of magnet fitting grooves 63B are formed in a bottom surface 63A of the cartridge mount portion 63 at angularly spaced positions in the circumferential direction for holding permanent magnets 33 therein. Furthermore, for fitting in an O-ring 68 which will be described hereinafter, an annular groove 63C is formed in the bottom surface 63A of the cartridge mount portion 63 at a position radially outward of the respective magnet fitting grooves 63B and the ejection air supply passage 15.

Indicated at 64 is a paint cartridge according to the present embodiment, to be replaceably set in the cartridge mount portion 63 of the housing 62. This paint cartridge 64 is largely constituted by a container 65, a conical projection 66 and a feed tube 67.

In this instance, similarly to the container 21 in the foregoing first embodiment, the container 65 of this embodiment is formed in a cylindrical shape which is slightly smaller in diameter than the cartridge mount portion 63 and closed at the opposite ends. A plural number of magnetic member fitting grooves 65B are formed in a front surface 65A of the container at angularly spaced positions in the circumferential direction for fitting magnetic members 34 therein. However, the container 65 of this embodiment differs from the container 21 of the foregoing first embodiment in that the annular groove 21D is abolished.

Indicated at 68 is an O-ring which is fitted in the annular groove 63C on the bottom surface 63A of the cartridge mount portion 63 to serve as a seal member. The O-ring 68 is hermetically engaged with the front surface 65A of the container 65 when the paint cartridge 64 is loaded into the cartridge mount portion 63 of the housing, forming an ejection air space 69 between the bottom surface 63A and the front surface 65A of the container 65.

In this instance, upon supplying ejection air through the ejection air supply passage 15, the ejection air space 69 is expanded to separate the container 65 away from the bottom surface 63A of the cartridge mount portion 63 against the magnetic force of the magnetic holding mechanism 32, permitting to dismantle the paint cartridge 64 from the cartridge mount portion 63.

Thus, according to the above-described third embodiment, the ejection air space 69 is defined by the O-ring 68 which is provided in the bottom surface 63A of the cartridge mount portion 63. Therefore, the O-ring 68 is simply brought into abutting engagement with the front surface 65A of the container 65, with less susceptibility to twisting deformation or sliding abrasion as compared with the conventional O-ring which is fitted around the outer periphery of the container. Thus, the arrangements of the present embodiment contribute to prolong the service life of the O-ring 68.

Further, as mentioned above, there is little possibilities of the O-ring 68 being deformed by twisting when the paint cartridge 64 is loaded into or unloaded from the cartridge mount portion 63. This means that the fore end of the feed tube 67 can be located at a center position in the rotary atomizing head 8. Therefore, the feed tube can supply paint smoothly toward the rotary atomizing head 8 and in such a way as to enhance the operational reliability of the cartridge type coating machine 61.

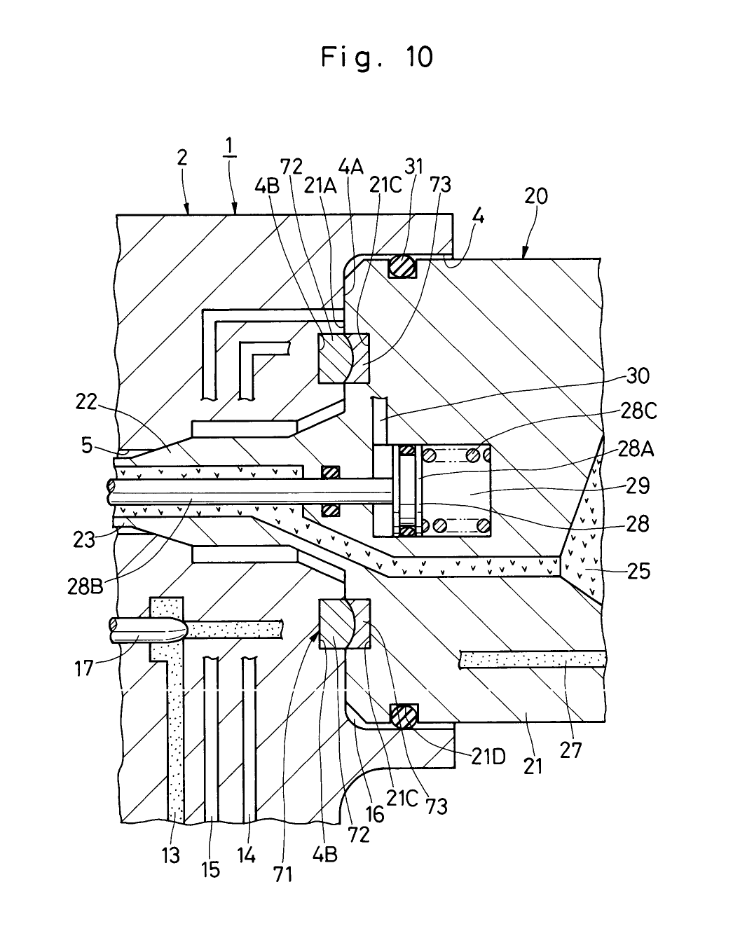

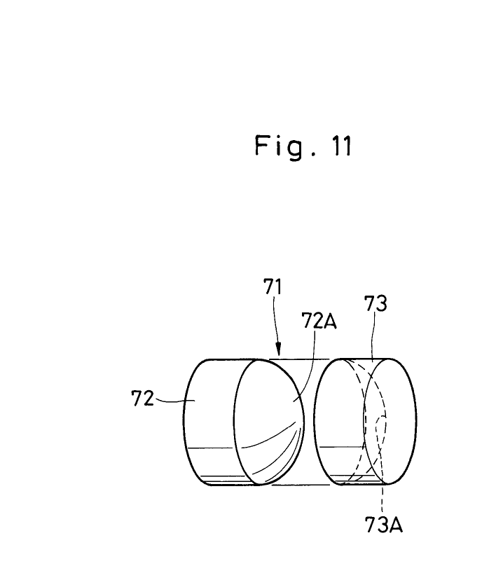

Turning now to FIGS. 10 and 11, there is shown a fourth embodiment of the present invention. This fourth embodiment has features in that projections and recesses of complementary shapes are provided on confronting surfaces of permanent magnets and magnetic members to be coupled with each other. In the following description of the fourth embodiment, those component parts which are identical with the counterparts in the foregoing first embodiment are simply designated by the same or similar reference numerals to avoid repetitions of the same explanations.

Indicated at 71 is a magnetic holding mechanism according to the present embodiment, which is provided between the cartridge mount portion 4 of the housing 2 and a paint cartridge 20. This magnetic holding mechanism 71 serves to hold the paint cartridge 20 in the cartridge mount portion 4 by magnetic attraction, and largely constituted by permanent magnets 72 and magnetic members 73, which will be described hereinafter.

Indicated at 72 are a plural number of permanent magnets which are fitted in magnet fitting grooves 4B on the side of the cartridge mount portion 4. As shown in FIG. 11, each one of the permanent magnets 72 is formed substantially in a short cylindrical shape. A convex projection 72A is formed on the outer surfaces of the permanent magnets 72 which confront magnetic members 73 which are provided on the side of the paint cartridge as described below.

Indicated at 73 are a plural number of magnetic members which are set in magnetic member fitting grooves 21C on the container 21. Each one of the magnetic members 73 is formed substantially in a short cylindrical shape. Further, each one of the magnetic members 73 are formed with a concave recess 73A on an outer surface which confronts one of the permanent magnets 72.

In this instance, as the paint cartridge 20 is loaded into the cartridge mount portion 4, the magnetic members 73 are attracted to the permanent magnets 72 to hold the paint cartridge 20 fixedly in the cartridge mount portion 4 by magnetic force. As the convex projection 72A of the permanent magnets 72 and the concave recesses 73A of the magnetic members 73 are formed of the gradually inclining surface, the positional deviations between the permanent magnets and the magnet members, if any, can be automatically corrected to set and fix the paint cartridge 20 accurately in position relative to the housing 2.

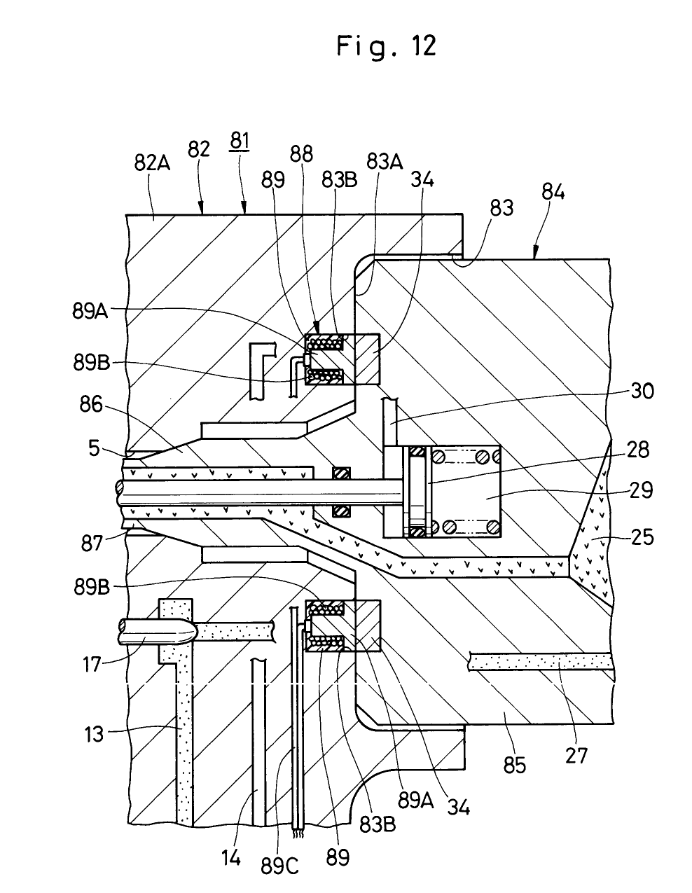

Turning now to FIG. 12, there is shown a fifth embodiment of the present invention. This embodiment has features in that a magnetic holding mechanism is constituted by electromagnets which are provided either on the side of the cartridge mount portion of the housing or on the side of a paint cartridge and magnetic member which are provided opposingly either on the side of the paint cartridge or on the side of the cartridge mount portion of the housing. In the following description of the fifth embodiment, those component parts which are identical with the counterparts in the foregoing first embodiments are simply designated by the same or similar reference numerals to avoid repetitions of the same explanations.

Indicated at 81 is a cartridge type coating machine according to the present embodiment, and at 82 is a housing of the coating machine 81. In this instance, similarly to the housing 2 of the foregoing first embodiment, the housing 82 of this embodiment is provided with a cartridge mount portion 83 in the form of a cylindrical cavity on the rear side of its head portion 82A. A plural number of electromagnets fitting grooves 83B are formed in a bottom surface 83A of the cartridge mount portion 83 at angularly spaced positions in the circumferential direction for fixing therein electromagnets 89 which will be described after. However, the housing 82 of this embodiment differs from the housing 2 of the first embodiment in that the ejection air supply passage 15 is abolished.

Designated at 84 is a paint cartridge according to the present embodiment. Similarly to the paint cartridge 20 of the first embodiment, the paint cartridge 84 is largely constituted by a container 85, a conical projection 86 and a feed tube 87. However, the paint cartridge 84 of this embodiment differs from the paint cartridge 20 of the first embodiment in that the annular groove 21D for the O-ring 31 is abolished from the container 85.

Indicated at 88 is a magnetic holding mechanism according to the present embodiment, which is provided between the cartridge mount portion 83 of the housing 82 and a paint cartridge 84. The magnetic holding mechanism 88 functions to fixedly hold the paint cartridge 84 in the cartridge mount portion 83 by magnetic attraction. The magnetic holding mechanism 88 is constituted by the above-described magnetic members 34, in combination with electromagnets 89 as described below.

Indicated at 89 are a plural number of electromagnets which are fixed in the electromagnets fitting grooves 83B on the side of the cartridge mount portion 83. For example, each one of the electromagnets 89 is an explosion-proof electromagnet having an iron core 89A and a coil winding 89B, both clad in a molded synthetic resin material. The coil winding 89B is connected to a power source through wiring 89C.

As soon as power is supplied through the wiring 89C, each electromagnet 89 is energized to produce magnetic force. In this state, upon loading the container 85 of the paint cartridge into the cartridge mount portion 83, the magnetic members 34 are attracted toward the electromagnets 89 to hold the paint cartridge 84 fixedly in the cartridge mount portion 83 by magnetic force. Upon cutting off power supply and de-energizing the electromagnets 89, the paint cartridge 84 can be easily dismantled or unloaded from the cartridge mount portion 83.

Thus, in the case of the fifth embodiment with the above-described arrangements with the electromagnets 89, the paint cartridge 84 can be easily dismantled upon turning off power supply to and de-energizing the electromagnets 89. Accordingly, in this case, it becomes possible to omit the ejection air supply passage for simplifying the construction of the coating machine.

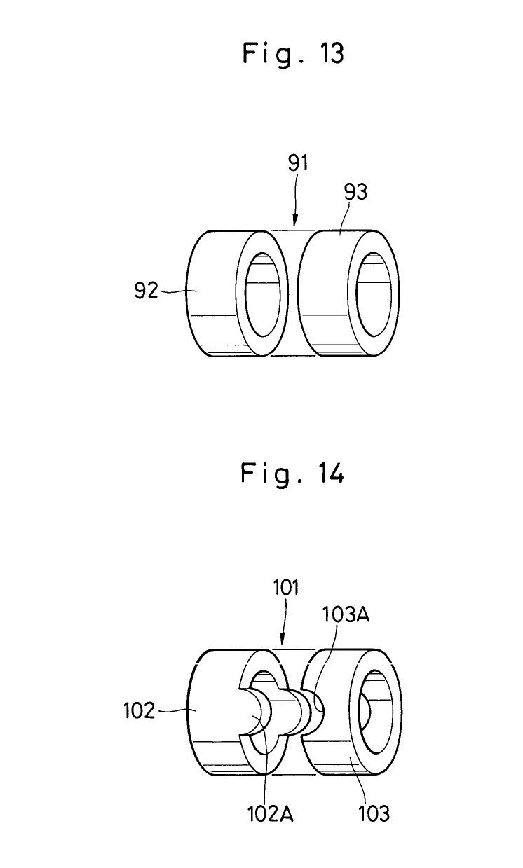

In the foregoing first embodiment, the permanent magnets 33 and magnetic members 34 of the magnetic holding mechanism 32 are each shown as being in a short cylindrical shape. However, the present invention is not limited to this particular example. For example, as shown as a first modification in FIG. 13, a magnetic holding mechanism 91 can be constituted by permanent magnets 92 and magnetic members 93 of tubular shape. This modification can be similarly applied to other embodiments of the present invention.

Further, as shown as a second modification in FIG. 14, there may be employed a magnetic holding mechanism 101 consisting of tubular permanent magnets 102 and magnetic members 103, each one of the permanent magnets having arcuate projections 102A at radially opposite positions for fitting engagement with arcuate recesses or notches 103A on the side of the magnetic member 103.

Further, in the case of the above-described fourth embodiment, the spherical or convex projections 72A are provided on the permanent magnets 72 for fitting engagement with concave recesses 73A which are provided on the side of the magnetic members 73. However, it is to be understood in this regard that the present invention is not limited to the particular example shown. For instance, conical projections may be provided either on the side of the magnets or on the side of the magnetic members for engagement with conical recesses or notches which are provided either on the side of the magnetic members or on the side of the magnets. If desired, the magnets and the confronting magnetic members may be engaged through projections and recesses of other shapes.

Further, according to the above-described first embodiment, the permanent magnets 33 and magnetic members 34 of the magnetic holding mechanism 32 are located at four angularly spaced positions in the circumferential direction. However, it is to be understood in this regard that the present invention is not limited to the particular example shown. For instance, the permanent magnets 33 and magnetic members 34 may be provided at two, three or more than five different positions which are angularly spaced in the circumferential direction.

Furthermore, in the foregoing embodiments, the paint passage 23A in the feed tube 23 of the paint cartridge 20 is shown as having a function as an inlet passage for a wash fluid like thinner, in addition to functions as a paint supply passage to be used at the time of supplying paint from the paint cartridge 20 and a paint replenishing passage to be used at the time of replenishing paint into the paint cartridge 20. However, the present invention is not limited to such arrangements. For example, like the paint cartridge which is described in Japanese Patent Laid-Open No. 2002-11396, a wash fluid passage may be provided in the container separately from the paint passage of the feed tube. In this case, on the part of a paint replenisher, a wash fluid passage is provided separately from a connector member which is arranged to permit paint flows into and out of the feed tube of the paint cartridge. At the time of washing a paint cartridge, a wash fluid is supplied to the paint cartridge from the wash fluid passage on the side of the paint replenisher through the wash fluid passage on the side of the cartridge.

Further, in the foregoing first embodiment, the cartridge mount portion 4 is formed in the shape of a flat cylindrical cavity with the bottom surface 4A, and the permanent magnets 33 are attached to the bottom surface 4A in confronting relation with the magnetic members 34 which are attached to the flat front surface 21A of the container 21. However, it is to be understood that the present invention is not limited to the particular arrangements shown. For instance, the bottom surface of the cartridge mount portion with the permanent magnets and the front surface of the container casing with the magnetic members may be formed complementarily in concave and convex shapes, respectively, if desired.

On the other hand, in the foregoing first embodiment, the cartridge type coating machine 1 is shown as being composed of the air motor 7 and the rotary atomizing head type sprayer unit 6 with the rotary atomizing head 8. However, the present invention is not limited to this particular type of coating machine. For example, the present invention can be similarly applied to cartridge type coating machines with other sprayer units such as a hydraulic atomization type or pneumatic atomization type sprayer unit. The same applies to other embodiments of the invention.

Moreover, in the foregoing first embodiment, by way of example thinner is used as an extruding liquid for pushing paint out of the container 21 of the paint cartridge 20. However, depending upon the type of paint and the method of high voltage application, water or other extruding liquid may be employed in place of thinner. The same applies to other embodiments of the invention.

1. A cartridge type coating machine including a housing with a sprayer unit mount portion and a cartridge mount portion respectively on front and rear sides thereof, a sprayer unit mounted on said sprayer unit mount portion of said housing to spray supplied paint toward a work piece, and a paint cartridge adapted to be replaceably set in said cartridge mount portion of said housing and filled with paint for supply to said sprayer unit, characterized in that said coating machine comprises:
a magnetic holding mechanism provided between said cartridge mount portion of said housing and said paint cartridge to releasably and fixedly hold said paint cartridge in said cartridge mount portion of said housing by magnetic force.

2. A cartridge type coating machine as defined in claim 1, wherein said magnetic holding mechanism is constituted by permanent magnets attached to one of said cartridge mount portion of said housing and said paint cartridge and magnetic members attached to the other one of said cartridge mount portion and said paint cartridge.

3. A cartridge type coating machine as defined in claim 1, wherein said magnetic holding mechanism is constituted by a first permanent magnet attached to one of said cartridge mount portion of said housing and said paint cartridge, and a second permanent magnet attached to the other one of said cartridge mount portion and said paint cartridge in such a way as to confront said first permanent magnet through inverse magnetic poles.

4. A cartridge type coating machine as defined in claim 1, wherein said magnetic holding mechanism is constituted by a first magnet group comprised by a plural number of permanent magnets and attached to one of said cartridge mount portion of said housing and said paint cartridge, said permanent magnets of said first magnet group being arranged in a row and alternately reversed in magnetic pole position, and a second magnet group comprised of a plural number of permanent magnets and attached to the other one of said cartridge mount portion of said housing and said paint cartridge, said permanent magnets of said second magnet group being arranged into a row in confronting relation with said first magnet group and reversed in magnetic pole position relative to said first magnet group.

5. A cartridge type coating machine as defined in claim 1, further comprising an ejection air supply passage is provided in said housing for supplying ejection air between said cartridge mount portion and said paint cartridge at the time of dismantling the latter from said cartridge mount portion of said housing.

6. A cartridge type coating machine as defined in claim 5, wherein said cartridge mount portion of said housing is formed in the shape of a bottomed cylindrical cavity, and said paint cartridge is provided with a cylindrical container filled with paint and a feed tube extended axially forward from a front end of said container, said coating machine further comprising a seal member provided either on a bottom surface of said cartridge mount portion or on a front surface of said container, said seal member being brought into abutting engagement with either said front surface of said paint cartridge or said bottom surface of said cartridge mount portion to form an ejection air space therebetween when said paint cartridge is set in said cartridge mount portion of said housing.

7. A cartridge type coating machine as defined in claim 2, wherein a projection and a recess of complementary shapes are provided on confronting surfaces of said permanent magnet and said magnetic member for fitting engagement with each other.

8. A cartridge type coating machine as defined in claim 3, wherein a projection and a recess of complementary shapes are provided on confronting surfaces of said first and second permanent magnets for fitting engagement with each other.

9. A cartridge type coating machine as defined in claim 1, wherein said magnetic holding mechanism is constituted by an electromagnet provided on one of said cartridge mount portion of said housing and said paint cartridge, and a magnetic member provided on the other one of said cartridge mount portion and said paint cartridge.
